(19) United States
(12) Patent Application Publication
(10) Pub. No.: US 2003/0175163 A1
(43) Pub. Date: Sep. 18, 2003

(54) Multiple dispenser

(76) Inventors: Igor Shvets, Dublin (IE); Sergei Makarov, Dublin (IE); Jurgen Osing, Dublin (IE); David Sweeney, Dublin (IE)

Correspondence Address: BIRCH STEWART KOLASCH & BIRCH, PO BOX 747, FALLS CHURCH, VA, 22040-0747, US

(21) Appl. No.: 10/098,393

(22) Filed: Mar. 18, 2002

(51) Int. Cl. B01L 3/02

(52) U.S. Cl. 422/100

(57) ABSTRACT

A multi nozzle dispensing head for a dispensing assembly for liquid droplets of 10 μl or less. The dispensing assembly comprises a pressurised liquid delivery source feeding a dispenser including a metering valve and the multi nozzle dispensing head. The multi nozzle dispensing head comprises a bored primary nozzle feeding a manifold forming a split channel which in turn feeds bored secondary nozzles. The aggregate resistance to flow in all the secondary nozzle bores is greater than the resistance to flow in the split channel, generally by a factor of 10.

### INTRODUCTION

The present invention relates to a multinozzle dispensing head for a dispensing assembly for liquid droplets of the order of 10 microlitres or less, the dispensing assembly being of the type comprising a dispenser comprising a metering valve connected to the dispensing head, the dispenser being, in turn, connected to a pressurised liquid delivery source. Further, the invention relates to a dispensing assembly for dispensing volumes of the order of 10 microlitres or less, the dispensing assembly having a metering valve connected to a pressurised liquid delivery source and a multinozzle dispensing head.

The present invention is generally related to liquid handling systems and in particular to systems for dispensing small volumes of liquids. It is primarily directed to High Throughput Screening (HTS), Polymerase Chain Reaction (PCR), combinatorial chemistry, microarraying, medical diagnostics and other similar tasks. In the area of high throughput screening, PCR and combinatorial chemistry, the typical application for such a fluid handling system is in dispensing small volumes of reagents, e.g. 1 ml and smaller and in particular volumes around 1 microlitre and smaller.

The present invention is also directed to medical diagnostics e.g. for printing reagents on a substrate covered with bodily fluids for subsequent analysis or alternatively for printing bodily fluids on substrates.

The invention, it is envisaged, may be used for an application called, in this specification, Bulk Reagent Dispensing (BRD) and more specifically for that aspect of the BRD in which the dispenser dispenses a multitude of identical droplets of the same liquid on a substrate or well plate. To increase the productivity of the dispenser it is important in this case to dispense the sample liquid through a number of channels in parallel, typically four, eight or twelve channels. The volume of each drop is small, typically in the range of several microlitres or even smaller.

Development of instrumentation for dispensing of minute volumes of liquids has been an important area of technological progress for some time. Numerous devices for controlled dispensing of small volumes of liquids (in the range of 1 μl and smaller) for ink jet printing application have been developed over the past twenty-five years. More recently, a wide range of new areas of applications has emerged for devices handling liquids in the low microlitre range. These are discussed for example in “Analytical Chemistry” [A. J. Bard, Integrated chemical systems, Wiley-Interscience Pbl, 1994]

The requirements of a dispensing system vary significantly depending on the application. For example, the main requirement of a dispensing system for ink jet applications is to deliver droplets of a fixed volume with a high repetition rate. The separation between individual nozzles should be as small as possible so that many nozzles can be accommodated on a single printing cartridge. On the other hand in this application the task is simplified by the fact that mechanical properties of the liquid dispensed namely ink are well defined and consistent.

For biomedical applications such as High Throughput Screening (HTS) the requirements imposed on a dispensing system are different. The system should be capable of handling a variety of reagents with different mechanical properties e.g. viscosity. Another requirement in the HTS applications is that cross contamination, between different wells served by the same dispensing device, be avoided as much as possible.

The most common method of liquid handling for the HTS applications is based on a positive displacement pump such as described in U.S. Pat. No. 5,744,099 (Chase et al). Examples of such positive displacement pumps are also disclosed in U.S. Pat. No. 5,744,099 (Chase et al). Similarly the problems of dispensing drops of small volume are also described and discussed in U.S. Pat. Nos. 4,574,850 (Davis) and 5,035,150 (Tompkins).

Dispensing of drops of liquids using a conventional solenoid valve is well known. One such example of application of solenoid valve for dispensing of small drops in ink jet printers is described in the UK patent specification GB 2260597A (Walton). U.S. Pat. No. 5,741,554 (Tisone) describes another method of dispensing submicrolitre volumes of fluids for biomedical application and in particular for depositing bodily fluids and reagents on diagnostic test strips.

Many of the problems encountered in dispensing were addressed in the following recent patent applications: U.S. patent application Ser. No. 09/816,326 (Allegro Technologies Ltd) entitled Liquid Droplet Dispensing, European patent application No 99650106.0 (The Provost, Fellows and Scholars of the College of the Holy and Undivided Trinity of Queen Elizabeth Near Dublin) entitled A Dispensing Method And Assembly For Liquid Droplets, U.S. patent application Ser. No. 09/709,541 (The Provost, Fellows and Scholars of the College of the Holy and Undivided Trinity of Queen Elizabeth Near Dublin) entitled A Dispensing Method And Assembly For Liquid Droplets and European patent application No 00650123.3 (Allegro Technologies Ltd) entitled Liquid Droplet Dispensing. These applications describe a dispensing assembly incorporating a dispensing device based on a boss of magnetic material actuated by a coil assembly coupled electromagnetically to it. There are no springs acting on the boss and it is therefore free to move in the main bore of the dispenser. The moving boss can open and close the nozzle of the dispensing device. The dispensing device is connected to a pressure/vacuum source. If the nozzle is open, the liquid is moved through the main bore and through the nozzle thus forming the drop that is then ejected from the tip of the nozzle. There are also means for detection of position of the boss as it moves within the main bore. These are required to accurately time the moments of opening and closing of the nozzle that is important for accurate dispensing of drops of small volume. These four patent applications describe a device capable of dispensing liquids in the volume range from above some several microlitres down to less than 10 nl. The device can handle liquids with a range of mechanical properties, e.g. high and low viscosity liquids. The patent applications further describe means for detection of the moment of droplet detachment from the tip, measurement of the volume of the droplet and means for navigation of the droplet as it travels between the tip and the destination substrate by using electrostatic field.

For certain applications, it is required to dispense liquids through a number of channels or nozzles in parallel in order to increase productivity of the dispensing assembly or dispenser. One possible solution is to use a number of such dispensers working simultaneously in parallel. This clearly increases the costs and complexity of the instrument. Still, for certain applications there is no alternative to using a number of nozzles in parallel, e.g. when different nozzles must dispense different liquids or need to be controlled separately. However, in some BRD applications, it is not necessary to have the flexibility of independent control for each nozzle or channel as all the nozzles must dispense the same volume of the same liquid. If it was possible to have one source of pressurised liquid and its associated valving, referred somewhat loosely below as the “dispenser”, as strictly speaking, the dispenser comprises a metering valve or device and its associated dispensing head or nozzle controlling a number of nozzles or channels such as eight, the design of the dispensing assembly would be simplified and its cost reduced.

Unfortunately, the obvious solution whereby one such dispenser is connected to a dispensing head comprising a number of nozzles by means of capillaries, usually leads to a situation where different channels dispense unequal volumes of liquids or where certain channels do not dispense drops at all. It has been found that for droplets below 10 microlitres, with a dispensing assembly having eight channels, For example, it may happen that out of eight channels, four dispense drops of comparable volume though still with a relatively large error of e.g. 20%, and out of the remaining four channels, two dispense one drop for every second actuation of the boss in the main bore (missing every second drop) and the other two channels dispense for every three actuations (missing two drops out of three). The situation usually gets worse as the volume of dispensation per channel decreases and typically in a low microlitre or submicrolitre volume such an approach does not work.

Typical application of this sort arises in BRD for filling all the wells on a well plate with the same liquid: each well is filled with the same liquid A and then different liquids B₁, B₂, B₃, . . . , B₉₆ etc are added to the different wells on the plate. To fill the well plate with the liquid A, a BRD multichannel dispenser is usually used in which all the channels must dispense the same volume of the same liquid and the independent control of the channels is not required. Typically such BRD dispenser must have 4, 8 or 12 channels or nozzles with separation between neighboring nozzles of 9 mm.

Currently, one of the two most common technologies used for such applications is based on peristaltic pump. The “Multidrop” instrument produced by Thermo Labsystems Oy is one example of a such a dispenser. The smallest volume that can be dispensed by a peristaltic pump is of the order of some 3 to 5 microlitres.

The second most common technology relies on a syringe pump, each channel typically needs to be controlled by a separate plunger of the pump. It is usually not sufficient to connect one syringe pump to a multitude of nozzles. The reason is that in this case the volumes of the droplets dispensed from the individual nozzles may not be equal. The problem becomes particularly significant when dispensing droplets of ten microlitres or less in volume. In this case, the variation between the volumes expelled from the individual nozzles tends to be particularly large and in some cases most of the volume expelled by the syringe pump is dispensed from a single nozzle. Providing separate plungers for the individual channels increases the cost and complexity of the dispenser.

In summary, there is a major problem in finding a suitable way of dispensing submicrolitre volumes for applications as described above. This problem can be said to be currently the bottleneck in changing to assay formats of higher density. Numerous publications in the specialised literature indicate that a technical solution to this problem has not been found so far. For example, according to surveys carried out by the journal Genetic Engineering News (Vol. 20, No. 2, January 2000), absence of an adequate technology for low volume liquid dispensing is named as the number one reason preventing researchers from moving to denser microplates.

The present invention is directed to providing an improved apparatus and method for simultaneous dispensing of small droplets of liquid through a number of channels. Typically droplets of equal volumes are to be dispensed from the channels. Typically volumes of droplets to be dispensed using the present invention are as small as 100 nl=10⁻⁷ I or even smaller, while at the same time it should be possible to dispense larger droplets such as those as large at 5 microlitres or even greater. This invention is directed to providing a multichannel or multinozzle dispensing head capable of dispensing four, eight, twelve or even more droplets simultaneously. It is an important objective of the invention to ensure that the variation in the volumes of the droplets dispensed from the separate channels is small.

Another objective is directed to providing a method where the quantity of the liquid dispensed can be freely selected by the operator and accurately controlled by the dispensing system. The system should be capable of dispensing drops of one size followed by drops of a widely differing size, for example, a set of 100 nl drops followed by a set of 1000 nl ones. This is in contrast to for example ink jet printing where the volume of one dispensation is fixed, and dispensations are only possible in multiples of this quantity.

The invention is also directed towards providing a method where the liquid can be dispensed on demand, i.e. one quantity can be dispensed at a required time as opposed to a series of dispensations with set periodic time intervals between them. Yet, the method should also allow for dispensation of doses with regular intervals between subsequent dispensations, for example, printing with reagents.

Another objective is to provide a low cost front end of the dispensing device called herein the dispensing head which can be disposed of when it becomes contaminated namely the part which comes in direct contact with the reagents dispensed. It is an important objective of the invention to provide a dispensing head such that the disconnection and replacement is achieved simply such as by an arm of a robot.

The invention is also directed to widening the application of the previously referred to inventions described in the previously mentioned patent applications, namely, U.S. patent application Ser. No. 09/816,326 (Allegro Technologies Ltd) entitled Liquid Droplet Dispensing, European patent application No 99650106.0 (The Provost, Fellow and Scholars of the College of the Holy and Undivided Trinity of Queen Elizabeth Near Dublin) entitled A Dispensing Method And Assembly For Liquid Droplets, U.S. patent application Ser. No. 09/709,541 (The Provost, Fellows and Scholars of the College of the Holy and Undivided Trinity of Queen Elizabeth Near Dublin) entitled A Dispensing Method And Assembly For Liquid Droplets and European patent application No. 00650123.3 (Allegro Technologies Ltd) entitled Liquid Droplet Dispensing. It is therefore another objective to ensure that all the beneficial features of these inventions such as navigation of droplets in the flight, detection of the moment of drop detachment from the tip, measurement of the volume of the droplet as it travels between the tip and the substrate, can be also used with the current invention.

### STATEMENTS OF INVENTION

Exemplary embodiments of the present invention provide a multi nozzle dispensing head for a dispensing assembly for liquid droplets of the order of 10 microlitres or less. The dispensing assembly includes a dispenser comprising a metering valve connected to the dispensing head. The dispenser is then in turn connected to a pressured liquid delivery source. The dispensing head comprises a primary nozzle for connection to the metering valve, a manifold forming a split channel fed from the primary nozzle and a plurality of secondary nozzles, each having an internal liquid dispensing secondary nozzle bore connected to the manifold. In accordance with the invention, the resistance to flow in all the secondary nozzles is greater than the resistance to flow in the split channel.

Increasing the resistance to the flow in the secondary nozzles is counterintuitive as one may expect, at first sight, that improving the flow in the secondary nozzles and reducing resistance to the flow should make dispensation from the secondary nozzles more uniform. As we show in this specification, using experimental data and theoretical models, the opposite is true.

Ideally, this resistance to flow is greater by a factor of ten.

In one embodiment of the invention, where each secondary nozzle is connected to the manifold, it is enlarged to form a smooth transition between the secondary nozzle bore and that of the split channel to assist in preventing the formation of air bubbles in the split channel. Similarly, the primary nozzle bore, where it is connected to the manifold, is enlarged to form a smooth transition between it and the split channel.

In one embodiment of the invention, the manifold comprises a glass bubble release valve connected to the split channel.

Ideally, each secondary nozzle projects proud of the dispensing head to form the dispensing tip. The external dimensions of the secondary nozzle may reduce in cross section towards the dispensing tip. The secondary nozzles may be arranged in a matrix of rows and columns or indeed in any other suitable arrangement such as in the one line or simply forming two or three outwardly projecting arms from the one central point.

In one embodiment of the invention, the dispensing head is a two part head in which at least the manifold and the secondary nozzle form the one separate unit releasably connected to the remainder of the dispensing head. When this happens, it is preferable that the separate unit comprises part of the primary nozzle, the other part being integral with the metering valve. This makes it relatively easy to replace dispensing heads.

In another embodiment of the invention, there is provided a dispensing assembly which comprises a pressurised liquid delivery source and a multi nozzle dispensing head as described above. In this particular embodiment of the invention, the pressurised liquid source provides a kinetic energy such that the kinetic energy of an individual droplet is greater than the surface energy of the droplet on the dispensing tip.

Similarly, it will be appreciated that the pressurised delivery source provides a sufficient acceleration to the liquid such that the individual droplets can be detached from the nozzle.

Ideally, the dimensions of the dispensing head, pressure in the pressurised liquid delivery source and characteristics of the liquid dispensed should satisfy the formula:

$$\frac{ρ \cdot {( {p}_{1} - {p}_{2} )}^{2} \cdot {r}^{14 / 3}}{σ \cdot {η}^{2} \cdot {l}^{5 / 3}} \geq 65 \cdot K > 100$$

where p₁−p₂ is the effective pressure difference across the multi nozzle dispensing head, provided by the liquid delivery source, l is the effective length of the multi nozzle dispensing head, r is the effective radius of the inner bore of the dispensing head, ρ is the liquid density, σ is the liquid surface tension, η is the viscosity of the liquid and K is a dimensionless constant whose value is a function of the internal shape of the dispensing head.

### DETAILED DESCRIPTION OF THE INVENTION

The invention will be more clearly understood from the following description of some embodiments thereof, given by way of example only, with reference to the accompanying drawings, in which:

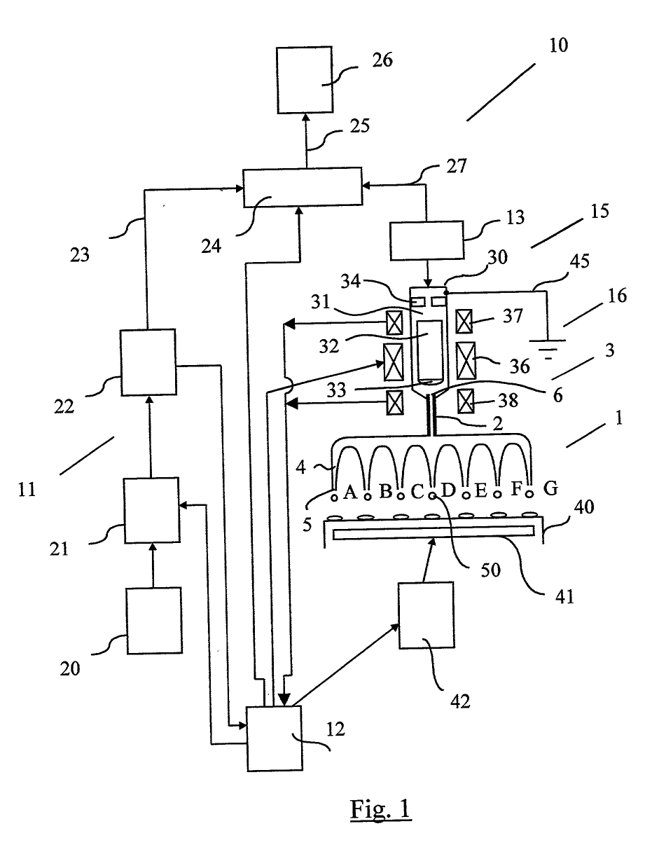

FIG. 1 is a diagrammatic view of a dispensing assembly according to the invention,

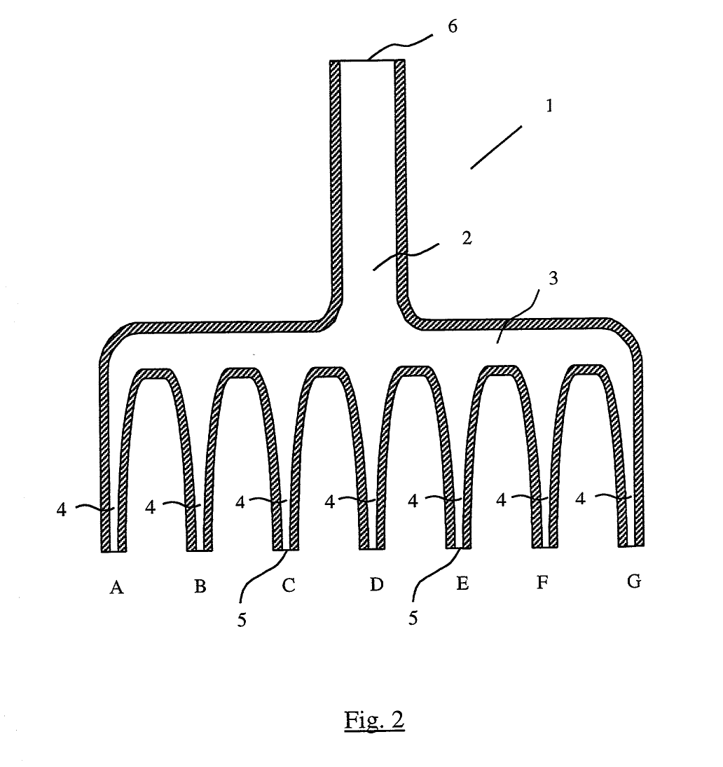

FIG. 2 is a sectional view of the multi nozzle dispensing head forming part of the dispensing assembly of FIG. 1 on an enlarged scale,

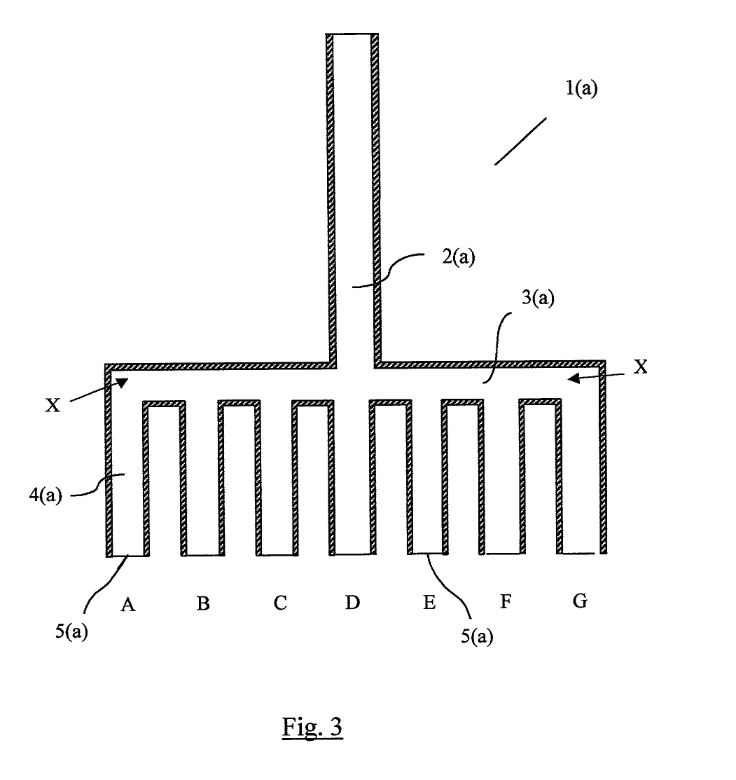

FIG. 3 is a sectional view of a conventional multi nozzle dispensing head,

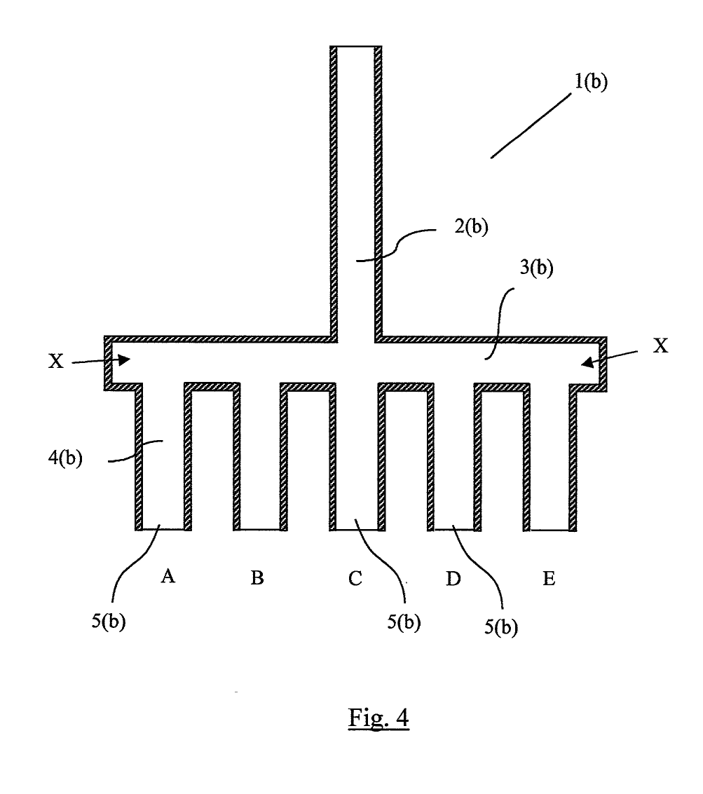

FIG. 4 is a sectional view of another conventional multi nozzle dispensing head,

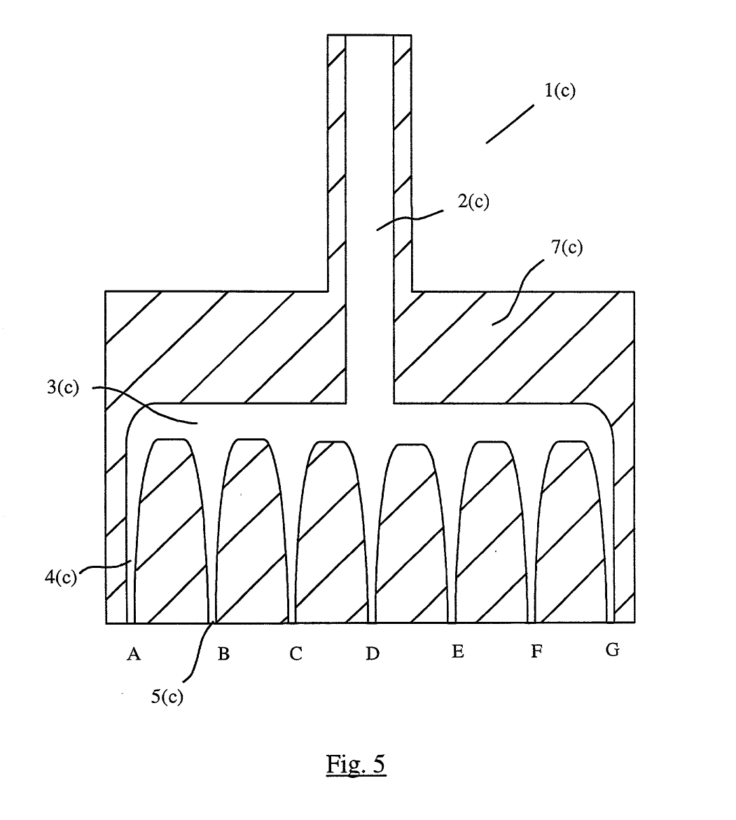

FIG. 5 is a sectional view of another construction of multi nozzle dispensing head according to the invention,

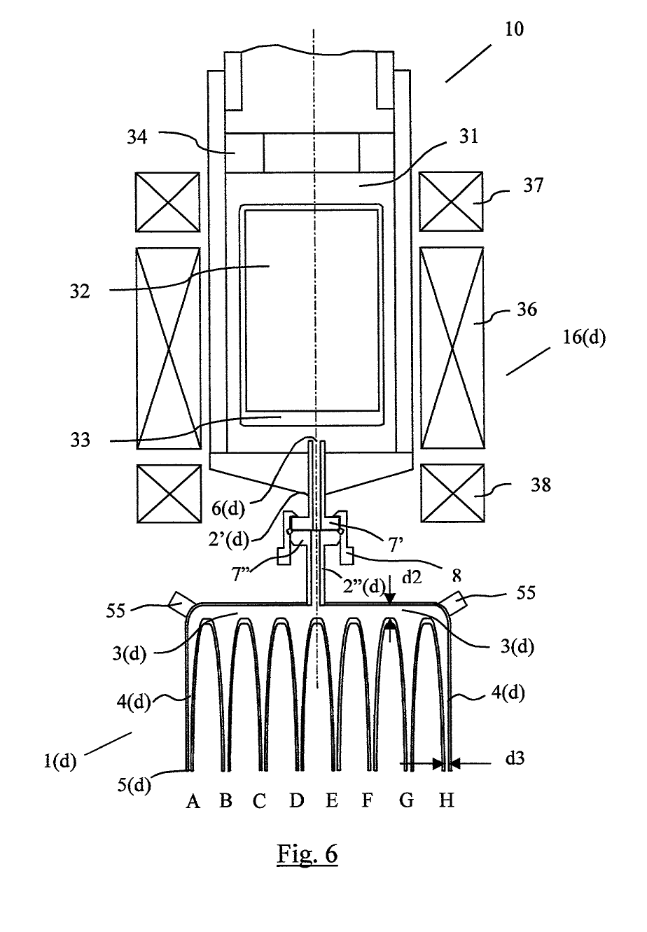

FIG. 6 is a diagrammatic view of portion of a dispenser and dispensing head forming a dispensing assembly according to the invention,

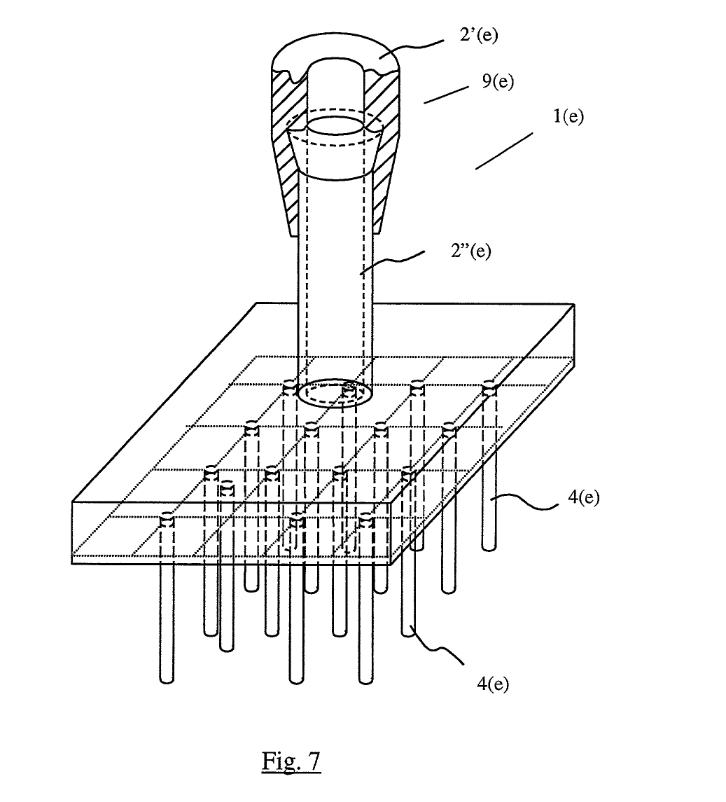

FIG. 7 is a part sectional, diagrammatic perspective view of a dispensing head according to the invention,

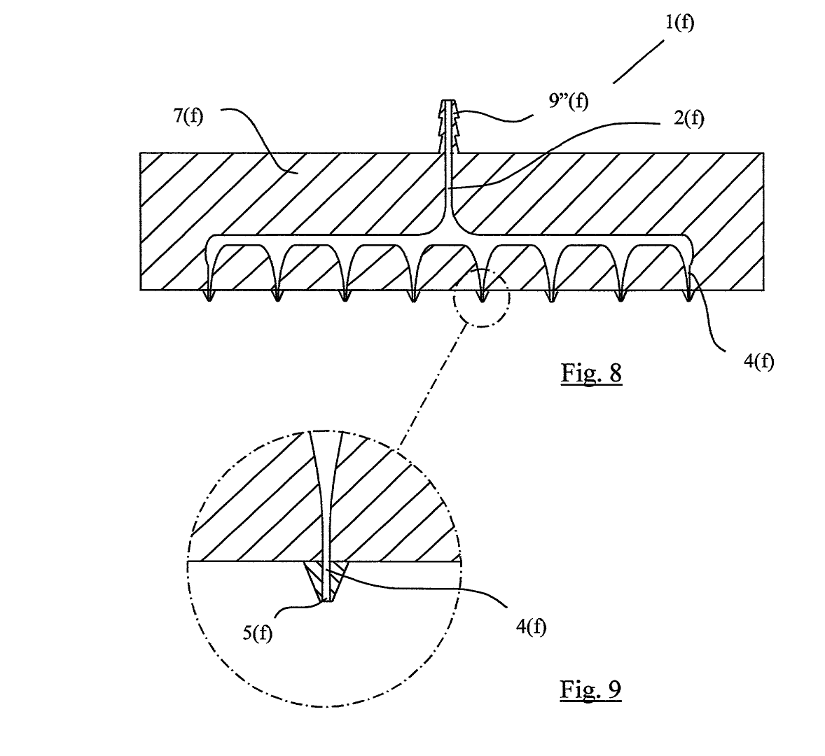

FIG. 8 is a front sectional view of a dispensing head according to the invention,

FIG. 9 is a detailed view of a circled portion of the dispensing head of FIG. 8,

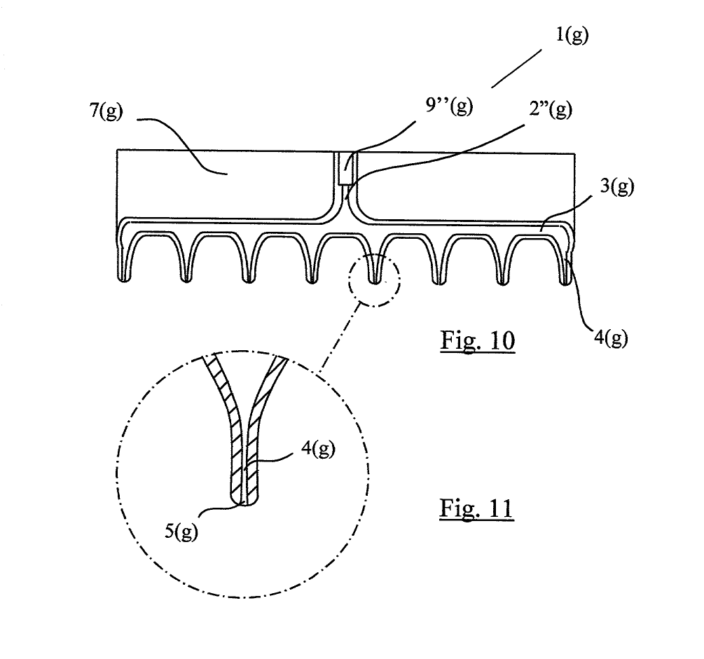

FIG. 10 is a front sectional view of another dispensing head according to the invention, and

FIG. 11 is a detailed view of a circled portion of the dispensing head of FIG. 10.

Referring initially to FIGS. 1 and 2, there is illustrated a multinozzle dispensing head, indicated generally by the reference numeral 1, mounted within a dispensing assembly, indicated generally by the reference numeral 10. Referring to FIG. 2, the multinozzle dispensing head 1 comprises a primary nozzle 2 connected to a manifold 3, forming a split channel which manifold 3 in turn feeds a plurality of secondary nozzles 4 each having a dispensing tip 5. The proximal end of the primary nozzle 2 forms a valve seat 6. The secondary nozzles 4 in FIG. 2 are identified by subscript letters A to G. Capital letters A to H are used as appropriate in all the drawings to show the location of each secondary nozzle 4. Briefly, the dispensing assembly 10 comprises a pressurised liquid delivery source, indicated generally by the reference numeral 11, an electronic controller 12, a sample liquid reservoir 13 and a dispenser, indicated generally by the reference numeral 15 which comprises a metering valve, indicated generally by the reference numeral 16, and the multinozzle dispensing head 1.

The pressurised liquid delivery source 11 comprises a pressure source 20 feeding a pressure regulator 21 which in turn feeds a pressure readout device 22. The pressure regulator 21 and the pressure readout device 22 are connected to the controller 12. The pressure readout device 22 is connected by a high pressure line 23 to a switch 24, which switch 24 is also fed through a vacuum line 25 from a vacuum pump 26. The switch 24 is connected to the controller 12 and to the sample liquid reservoir 13 by a further pressure line 27. The sample liquid reservoir 13 feeds the dispenser 15. It should be noted that a sample liquid reservoir 13 is not always required.

The metering valve 16 comprises a valve body 30 having a main bore 31 carrying a valve boss 32 of a permanent magnetic material such as SmCo and is coated with a layer of protective polymer material. The valve boss 32 has a front end 33 which is rounded and coated by a soft polymer material. The valve boss 32 is a loose fit within the main bore 31 which also mounts a stopper 34, an actuating coil assembly 36. Upper and lower sensing coils 37 and 38 respectively are provided, all the coils 36, 37 and 38 being connected to the controller 12.

The multinozzle dispensing head 1 is connected to the metering valve 16 by the primary nozzle 2 which, it will be seen, projects into the valve body 30. Mounted beneath the dispensing head 1 is a droplet receiving substrate 40 below which is mounted a conducting plate 41 connected to a high voltage source 42 which is in turn connected to the controller 12. Finally, the valve body 30 is grounded by an earth line 45. This, in effect, makes each dispensing tip 5 an electrode and thus there has to be an electric field formed between the receiving substrate 40 and the dispensing tips 5. Accordingly, the construction of the multinozzle dispensing head 1 and the metering valve 16 must be so arranged as to make this electrical connection 45.

It is advantageous to now describe, in detail, how the dispensing assembly works, without describing the features of the multinozzle dispensing head 1. Then, it is necessary to describe the construction of the multinozzle dispensing head 1 and experiments carried out on conventionally constructed dispensing heads.

In operation, liquid is stored in the main bore 31 of the valve body 30 having been delivered thereto from the sample liquid reservoir 13. The controller 12 is operated to activate the actuating coil assembly 36 to raise the valve boss 32 off the valve seat 6 to allow the liquid, pressurised by the pressure source 20, to pass between the valve boss 32 and the inner sides of the main bore 31 down in through the primary nozzle 2 into the manifold 3 and then into the secondary nozzles 4 until the actuating coil assembly 36 is again activated by the controller 12 to shut off the metering valve 16.

When the metering valve 16 is opened, the liquid is delivered to the dispensing tips 5(a) to (g) and droplets 50 will grow thereon. The volume of size of the droplets 50 is determined by the length of time the metering valve 16 is opened and by the viscosity of the liquid, the cross sectional area of the bore of the primary nozzle 2 and its length, the cross sectional area of the bores of the secondary nozzles 4 and their length, and also the pressure exerted on the liquid through the metering valve 16 from the pressurised liquid delivery source 20.

The sensing coils 37 and 38 are necessary to monitor movement of the boss 32 and therefore control the current supplied into the actuating coil 36.

It will be appreciated that if the pressure exerted on the liquid is sufficiently above ambient pressure which would normally be atmospheric pressure, the droplets 50 will be ejected from the dispensing tips 5. However, when the pressure is too low or indeed, in many cases, for accuracy, a relatively high voltage is applied to the conducting plate 41 by the high voltage source 42 which is activated by the controller 12. This would cause an electrostatic field to be exerted between the dispensing tips 5 and the droplet receiving substrate 40 thus causing the droplets 50 to be pulled downwards onto the substrate 40 by this electrostatic force, which force is generally considerably greater than gravity.

To aspire liquid from a substrate or indeed from any reservoir or container, the vacuum pump 26 may be operated and the switch 24 used to ensure that the vacuum pump 26 and the vacuum line 25 are connected with the dispensing head 1. At this stage, the high pressure line 23 will be disconnected by the switch 24. The valve boss 32 is lifted and the liquid can then be sucked up through the dispensing tips 5, secondary nozzles 4, manifold 3 and primary nozzle 2. Normally, this would simply be into the main bore 31. Needless to say, if desired, the liquid could also be stored in the sample liquid reservoir 13.

Referring again to FIG. 2 and then to FIGS. 3 and 4 which also illustrated multinozzle dispensing heads, identified by the reference numerals 1(a) and 1(b) respectively, with the relevant parts also identified by subscript letters (a) and (b) respectively, the theory and operation of the multinozzle dispensing head 1 will be described in more detail. Again, the position of the various secondary nozzles 4(a) and (b) are identified by the capital letters A to G, A to G and A to E respectively.

Before discussing, in more detail, the construction of the various multinozzle dispensing heads 1, 1(a) and 1(b), it is necessary to consider the flow of liquid within multinozzle dispensing heads.

Let us consider liquid with dynamic viscosity η flowing in a capillary tube having a bore of inner radius r. Suppose, length of the segment of the tube is l and the pressure values at the two ends of the segment are p₁ and p₂. The velocity uₐ of the liquid across the cross-section of the capillary will not be uniform. Instead, velocity at a point a will be a function of the separation x of the point a from the axis of the capillary. The velocity is greatest at the centre of the capillary. It decreases towards its walls and is effectively equal to zero at the walls of the capillary. The velocity therefore can be described by a function u(x). One can show that if we assume the flow in the capillary is laminar which is reasonable for the practical range of the tube radius of about 100 micrometres, the function u(x) is as follows:

$$u ( x ) = \frac{( {p}_{1} - {p}_{2} ) \cdot {r}^{2}}{4 \cdot η \cdot l} \cdot ( 1 - \frac{{x}^{2}}{{r}^{2}} ) \qquad ( 1 )$$

If we integrate this formula over entire cross-section of the capillary, we can obtain formula for the flow of liquid in the capillary:

$$Q = \frac{π \cdot {r}^{4} \cdot ( {p}_{1} - {p}_{2} )}{8 \cdot η \cdot l} \qquad ( 2 )$$

We define the ratio (p₁−p₂)Q as the resistance to the flow R_{f} by the segment of capillary. One can see that the resistance to the flow is proportional to the length of the segment and inversely proportional to the fourth power of its inner radius.

Let us consider two identical segments each having a resistance to the flow R_{f}. Then, if the two pieces are installed in series, the total resistance to the flow is 2R_{f}. In the same way, if n such segments are installed in series, the resistance to the flow is nR_{f}. If the two segments are installed in parallel, then the resistance to the flow is R_{f}/2 and if n pieces are installed in parallel, then resistance to the flow is R_{f}/n.

We can now formulate the first two conditions for a properly functional multinozzle dispensing head that was established experimentally:

1. Resistance to the flow of all the secondary nozzles should be preferably identical.

2. Resistance to the flow from the manifold forming split channel must be considerably smaller than the equivalent resistance to the flow from the secondary nozzles. Therefore if the resistance from a single secondary nozzle is R_{sec} and the number of secondary nozzles is n_{sec} and the resistance of the split channel is Rₛₚₗᵢₜ, then the condition can be written as:

R_{sec}/n_{sec}>>Rₛₚₗᵢₜ

To understand the rationale behind the third and fourth conditions, given below to ensure the construction of a properly functioning nozzle, we need to consider, in detail, separation of the drop from the nozzle. Suppose, in the embodiment of FIG. 1, the magnetic valve boss 32 is actuated and liquid in the channels of the secondary nozzles 4 is given a kick, i.e a pressure differential is applied along the channel. The liquid will be accelerated and after a certain time interval tₐ it will reach saturation velocity u. Under the constraints of practical values of diameters of the nozzles, their lengths and the pressure values in the pressurised liquid delivery source, this saturation value of the velocity will be reached almost instantaneously, meaning that the time tₐ is much smaller than the typical dispensation time. Then the valve boss 32 closes the valve seat 6 and the liquid in the primary nozzle 2 and hence each secondary nozzle 4 continues moving by inertia. If velocity u of the liquid in the capillary forming the secondary nozzle 4 is large enough, the bar of liquid that left the capillary exits the nozzle 4 and forms a droplet on the dispensing tip 5 and then separates from the secondary nozzle 4. If the velocity of the liquid is not large enough, the droplet 50 remains attached to the dispensing tip 5 and dispensation does not occur.

To understand what determines the critical value of velocity required to achieve the separation, we calculate kinetic energy of a bar of liquid of length l moving in a capillary. If the density of the liquid is ρ and velocity of the liquid at a point in the capillary separated by distance x from its axis is u(x), then the kinetic energy T is:

$$T = \int ⅆ m \cdot {u}^{2} / 2 = ρ \cdot l \cdot {\int }_{0}^{r} ⅆ S ( x ) \cdot {u}^{2} ( x ) / 2 = π \cdot ρ \cdot l \cdot {\int }_{0}^{r} {u}^{2} ( x ) \cdot x \cdot ⅆ x \qquad ( 3 )$$

Here

dS(x) is the element of area in the integral,

dm(x) is the element of mass of liquid in the integral,

x is the radius variable.

If we substitute the formula of formula (1) for the u(x) into formula (3), we get the following result:

$$T = \frac{π \cdot ρ \cdot {( {p}_{1} - {p}_{2} )}^{2} \cdot {r}^{6}}{96 \cdot {η}^{2} \cdot l} \qquad ( 4 )$$

If the capillary is not of circular cross section but e.g. of square or rectangular cross-section, the formula changes to some extent. However, the teaching of the formula (4) does not change: if the cross-sectional area S_{cap} of the capillary is scaled down, the kinetic energy T is rapidly reduced approximately in proportion to the third power of S_{cap}. For example, if the area is reduced by a factor of 2, the kinetic energy is reduced by a factor of approximately 8. The kinetic energy is also inversely proportional to the length of the capillary l.

The separation of the droplet will occur if the kinetic energy is considerably greater than the energy E required to create the surface for this volume:

T>E·K (5)

Here K is a dimensionless constant of the order of 10 or 100. K depends on how efficiently the kinetic energy can be converted into the surface energy. It therefore depends on the shape of the nozzle, e.g. K will be different for circular and rectangular nozzles. From the formulas (4) and (5) we will get the criterion for the successful separation of droplet:

$$\frac{ρ \cdot {( {p}_{1} - {p}_{2} )}^{2} \cdot {r}^{14 / 3}}{σ \cdot {η}^{2} \cdot {l}^{5 / 3}} \geq 65 \cdot K \qquad ( 6 )$$

On the basis of this formula we can obtain values for the minimum radius of the capillary. For example, if we take

ρ is 1000 kg/m³,

η is 0.001 Pa-s

Tube length l is 0.03 m

K value is 30,

Pressure difference p₁−p₂ is 2 Bar,

We obtain the value of 55 micrometres for the radius of the capillary.

In the case of the manifold one should take into account resistance to the flow from the primary nozzle, split channel and the secondary nozzle when calculating the equivalent of the formula (3). However, from the condition (2) above, one can see that the resistance to the flow in the split channel is negligibly small. We therefore need to take into account only the resistance to the flow in the primary nozzle and secondary nozzle.

We can now formulate the third condition as:

$$\frac{ρ \cdot {( {p}_{1} - {p}_{2} )}^{2} \cdot {r}^{14 / 3}}{σ \cdot {η}^{2} \cdot {l}^{5 / 3}} \geq 65 \cdot K > 100$$

Here p₁ is the pressure in the split channel formed by the manifold, not in the main bore 31 to take into account the fact that there is pressure drop in the primary nozzle 2. For example, if the resistance to the flow in the primary nozzle 2 is comparable to the equivalent resistance in all the secondary nozzles 4, then the pressure difference p₁−p₂ is approximately half of the pressure P_{source} generated by the pressurised liquid delivery source. On the other hand if the resistance to the flow in the primary nozzle 2 is very small by comparison with equivalent resistance of the secondary nozzles, then p₁ is almost equal to the pressure P_{source}.

The fourth condition becomes clear from the analysis of the constructions of FIGS. 3 and 4. Before the very first set of droplets are dispensed, the entire manifold must be filled up with liquid. If some areas of the manifold contain gas pockets, the accuracy of dispensation will be compromised as the gas is compressible and can absorb the pressure pulse in the manifold during opening of the valve seat. For example, we have established experimentally that in the manifold shown in FIG. 3, the two areas identified by the arrows X in the corners in the manifold 3(a) forming the split channel tend to contain bubbles of air. This air can not be easily removed from the manifold 3(a). The effect of it is that liquid in the secondary nozzles 4(a) located close to the gas pockets, namely, two peripheral nozzles, in locations A, G, is not accelerated to the same velocity as in the central nozzle. The action of the air bubbles is similar to that of springs or shock absorbers. This means that the volume of the liquid expelled from these peripheral secondary nozzles is different from the one in the centrally located ones, namely at locations C, D and E. FIG. 4 shows an example of an even worse case than the one shown in FIG. 3. This dispensing head 1(b) has a manifold 4(b) which will create even larger air pockets at the two ends of the split channel, again indicated by the arrows X. This brings us to the fourth condition.

All the transitions from primary nozzle into the manifold forming split channel and from the split channel into the secondary nozzles are preferably smooth so that the air bubbles cannot accumulate in the manifold.

Referring now to the multinozzle dispensing head 1(a) of FIG. 3, a dispensing head 1(a) was used in which the diameter of the primary nozzle 1(a), manifold 3(a) and secondary nozzles 4(a), were 150 microns. The pressure exerted during dispensation was in the range from 2 bar to 8 bar. The duration of the opening of the metering valve 16 was set so as to produce, as close as possible, a dispensation of 100 nl from the secondary nozzle 4(a) at location D.

Then the volumes dispensed from other channels were measured by dispensing into a metering capillary 10 drops and monitoring the level in the capillary. The accuracy of the measuring of the volume of dispensations was 5%. One should note that since the values of dispensations per channel presented in the table are averaged over 10 dispensations, the actual situation was even worse as the accuracy of a single drop dispensation was lower. The liquid dispensed was water at room temperature. The peripheral secondary nozzles 4 at locations A and G often missed droplets completely most likely due to the bubbles of air that were located inside the split channel and were very hard to remove. The results were therefore dependant on the conditions of the prior dispensations that could displace the bubbles inside the split channel. However, the results presented in the Table 1 are representative of the performance of the manifold.

TABLE 1

| | Channel | Channel | Channel | Channel | Channel | Channel | Channel |
|---|---|---|---|---|---|---|---|
| Location | A | B | C | D | E | F | G |
| Pressure | 0 μl | 70 μl | 90 μl | 100 μl | 95 μl | 80 μl | 0 μl |
| 2 Bar | | | | | | | |
| Pressure | 0 μl | 75 μl | 95 μl | 100 μl | 97 μl | 83 μl | 0 μl |
| 3 Bar | | | | | | | |
| Pressure | 0 μl | 78 μl | 95 μl | 100 μl | 94 μl | 85 μl | 70 μl |
| 5 Bar | | | | | | | |
| Pressure | 0 μl | 75 μl | 95 μl | 100 μl | 95 μl | 85 μl | 75 μl |
| 8 Bar | | | | | | | |

### Experimental Results Obtained with Conventional Manifold

These experiments show quite clearly that the following conditions must be fulfilled in order to ensure that drops of equal volume are dispensed from the individual dispensing tips.

1. During the dispensing, resistance to the flow in the split channel must be considerably smaller than the resistance to the flow in the secondary nozzle. Preferably it should be smaller than the resistance to the flow in a single secondary channel divided by the number of secondary nozzles in the dispenser.

2. During the dispensing, resistance to the flow in the secondary channel divided by the number of channels should be preferably greater than the resistance to the flow in the primary channel.

Significant deviations from these conditions results in increased inaccuracy in the dispensations between the individual dispensing tips. These conditions are discussed in detail below.

In a typical embodiment, the primary nozzle is a capillary with the inner diameter of some 0.25 mm and length 30 mm, the split channel is a capillary with the diameter of some 1 mm and the secondary nozzles are capillaries with the inner diameter of some 0.25 mm and length of 10 mm. The separation between the subsequent secondary nozzles is 9 mm. The pressure in the main bore of the dispenser is some 2 to 5 Bar.

Referring now to FIG. 5, there is illustrated an alternative construction of multinozzle dispensing head, indicated generally by the reference numeral 1(c), in which parts similar to those described with reference to the previous drawings are identified by the same reference numerals using the subscript letter “c”. In this embodiment, the multinozzle dispensing head 1 is manufactured of two solid blocks 7(c) of a suitable material such as perspex by means of a suitable technique such as hot embossing.

Referring to FIG. 6, there is illustrated an alternative construction of the multinozzle dispensing head, indicated generally by the reference numeral 1(d), in which parts similar to those described with reference to the previous drawings, are identified by the same reference numerals, with the subscript letter “d”. In this embodiment, the primary nozzle 2(d) is effectively a two-part nozzle, namely, the upper part identified by the reference numeral 2′(d) and the other identified by the reference numeral 2″(d), each terminating in a flange 7′ and 7″ connected together by a clip 8 mounted on the flange 7″. The remainder of the metering valve 16 is identical to that described already with reference to FIGS. 1 and 2, except that there is an additional secondary nozzle 4, shown in the position H. Further, the manifold 3(d) incorporates two spaced-apart bubble release valves 55.

Referring to FIG. 7, there is illustrated an alternative construction of multinozzle dispensing head, indicated generally by the reference numeral 1(e), comprising a manifold 3(e) mounting a plurality of secondary nozzles 4(e) arranged in rows and columns. The primary nozzle 2(e) is again a two part nozzle with a push-on quick-fit connector, identified generally by the reference numeral 9(e) between the upper part 2′(e) and the lower part 2″(e).

Referring to FIGS. 8 and 9, there is illustrated an alternative construction of multinozzle dispensing head, indicated generally by the reference numeral 1(f) having a main body 7(f) above which projects a lower portion of the primary nozzle 2″(f) which forms a push-in male connector 9″(f) to a female connector integral with an upper portion (both not shown) of the primary nozzle 2(f). Each secondary nozzle 4(f) terminates in a dispensing tip 5(f) proud of the main body 7(f). The secondary nozzle 4(f) has a dispensing tip which projects approximately 1 mm proud of the main body 7(f) and has a bore of 0.16 mm. The total full bore, that is to say, the bore of minimal cross-sectional area in the secondary nozzle 4(f) is approximately 2 mm in length, after which it gradually increases in cross-section, as can be seen in FIG. 9. The primary nozzle 2(f) has an internal diameter of approximately 0.4 mm and has a bore of approximately 9 mm in length. This is a typical construction that would be useful in accordance with the present invention. Separation between neighbouring secondary nozzles is 9 mm.

Table 2 illustrates experimental results obtained with the manifold of FIGS. 8 and 9 which fulfils the criteria of the present invention.

TABLE 2

| | Channel | Channel | Channel | Channel | Channel | Channel | Channel |
|---|---|---|---|---|---|---|---|
| Location | A | B | C | D | E | F | G |
| Pressure | 98 μl | 100 μl | 99 μl | 100 μl | 98 μl | 97 μl | 97 μl |
| 2 Bar | | | | | | | |
| Pressure | 99 μl | 100 μl | 98 μl | 100 μl | 98 μl | 98 μl | 98 μl |
| 3 Bar | | | | | | | |
| Pressure | 99 μl | 99 μl | 99 μl | 100 μl | 98 μl | 98 μl | 99 μl |
| 5 Bar | | | | | | | |
| Pressure | 99 μl | 100 μl | 99 μl | 100 μl | 98 μl | 98 μl | 99 μl |
| 8 Bar | | | | | | | |

FIGS. 10 and 11 illustrate a further multi nozzle dispensing head, indicated generally by the reference numeral 1(g), substantially the same construction as the multi nozzle dispensing head of FIGS. 8 and 9, except that there is now provided a different construction of secondary nozzle 4(g) having a rounded dispensing tip 5(g). ideally, the secondary dispensing nozzle, or at least that portion of it adjacent the dispensing tip 5(g), is of a hydrophobic material. The multi nozzle dispensing head 1(g) again has a main body 7(g), a two part primary nozzle 2(g), only the lower portion 2″(g) is illustrated, which lower portion 2″(g) terminates in a female connector 9″(g) for connection to a male connector integral with an upper portion (both of which are not shown) of the primary nozzle 2(g).

As has been explained already, in conventional multinozzle dispensing heads, all that usually happens is the number of identical secondary nozzles are added to the manifold or split channel. The cross-sections of the primary nozzle, split channel and all the secondary nozzles are of essentially the same size having almost identical cross-sections, usually with internal diameters of some 100 μm to 300 μm. As has been mentioned already, a typical malfunction is that the droplets dispensed through the peripheral secondary nozzles, that is to say, the ones further outwards, will become smaller than the ones dispensed through the centrally located secondary nozzles. The inequality between the drop becomes greater as the volume of each drop gets smaller. It was also observed that the droplets from some peripheral secondary nozzles were not dispensed each time.

It will be appreciated that the rest of the dispensing assembly according to the invention is substantially similar to the dispensing assemblies described in the various pending patent applications in respect of the four specifications of U.S. patent application Ser. No. 09/816,326 (Allegro Technologies Ltd) entitled Liquid Droplet Dispensing, European patent application No 99650106.0 (The Provost, Fellows and Scholars of the College of the Holy and Undivided Trinity of Queen Elizabeth Near Dublin) entitled A Dispensing Method And Assembly For Liquid Droplets, U.S. patent application Ser. No. 09/709,541 (The Provost, Fellows and Scholars of the College of the Holy and Undivided Trinity of Queen Elizabeth Near Dublin) entitled A Dispensing Method And Assembly For Liquid Droplets and European patent application No 00650123.3 (Allegro Technologies Ltd) entitled Liquid Droplet Dispensing. All the methods of electrostatic drop-off, droplet navigation and measurement of the volume of the drop as described in detail in European Patent Application No. 00650123.3 and European Patent Application No. 99650106.0 can also be used with the present invention, as well as the methods of control of boss movement by means of sensing coils and feedback.

In a typical embodiment, the pressure source and pressure regulator can be replaced for a compressor and integrating chamber. The compressor is controlled by an electronic controller. The compressor pressurises the integrating chamber. The pressure readout device is attached to the chamber and measures the pressure in it. Once pressure in the integrating chamber falls below a certain threshold Pₜₕ₁, the compressor starts pumping air into the chamber. Then, once the pressure in the chamber exceeds the threshold value Pₜₕ₂, the compressor is switched off. In a typical embodiment the difference between the values Pₜₕ₂ and Pₜₕ₁ is in the range of 0.05 Bar, e.g. Pₜₕ₂ is 3.00 Bar and Pₜₕ₁ is 3.05 Bar. The volume of the integrating chamber should be considerably greater than the inner volume of the pressure line and inner volume of the dispensers. We have found that in a typical embodiment, the volume of the integrating chamber of 0.2 litres is adequate.

Certain types of compressors can simultaneously pressurise one chamber and pump out another one. Therefore, one compressor having these features can be connected to two integrating chambers both equipped with pressure readout devices, release valves and valves between the chambers and the compressor. All the valves are controlled by the electronic controller. This arrangement can replace vacuum pump, pressure source, pressure regulator and pressure readout device as shown in FIG. 1.

In the specification the terms “comprise, comprises, comprised and comprising” or any variation thereof and the terms “include, includes, included and including” or any variation thereof are considered to be totally interchangeable and they should all be afforded the widest possible interpretation.

The invention is not limited to the embodiments hereinbefore described but may be varied in both construction and detail within the scope of the claims.

1. A multi nozzle dispensing head for a dispensing assembly for liquid droplets of the order of 10 microlitres or less, the dispensing assembly being of the type comprising:
a pressurised liquid delivery source; and
a dispenser comprising a metering valve connected to the pressurised liquid delivery source and a multi nozzle dispensing head for dispensation of droplets, connected to the metering valve:
the multi nozzle dispensing head comprising:
a primary nozzle, having an internal liquid dispensing primary nozzle bore, connected to the metering valve adjacent its proximal end;
a manifold connected to the primary nozzle adjacent its distal end and forming an internal split channel for reception of liquid from the primary nozzle bore; and
a plurality of secondary nozzles, each having an internal liquid dispensing secondary nozzle bore, each secondary nozzle being connected adjacent its proximal end to the manifold for reception of liquid therefrom and having a dispensing tip adjacent its distal end in which the aggregate resistance to flow in all the secondary nozzle bores is greater than the resistance to flow in the split channel.

2. A dispensing head as claimed in claim 1, in which each secondary nozzle bore, where it is connected to the manifold, is enlarged to form a smooth transition between its bore and that of the split channel to assist in preventing the formation of air bubbles in the split channel.

3. A dispensing head as claimed in claim 1, in which the primary nozzle bore, where it is connected to the manifold, is enlarged to provide a smooth transition between it and the split channel.

4. A dispensing head as claimed in claim 1, in which the manifold comprises a gas bubble release valve connected to the split channel.

5. A dispensing head as claimed in claim 1, in which each secondary nozzle projects proud of the dispensing head to form the dispensing tip.

6. A dispensing head as claimed in claim 5, in which the external dimensions of the secondary nozzle reduces in cross-section towards the dispensing tip.

7. A dispensing head as claimed in claim 1, in which the secondary nozzles are arranged in a matrix of rows and columns.

8. A dispensing head as claimed in claim 1, in which the dispensing head is a two part head in which at least the manifold and the secondary nozzles form the one separate unit releasably connected to the remainder of the dispensing head.

9. A dispensing head as claimed in claim 8, in which the separate unit comprises part of the primary nozzle, the other part being integral with the metering valve.

10. A dispensing head as claimed in claim 1, in which the resistance to flow is greater by a factor of ten.

11. A dispensing head as claimed in claim 10, in which each secondary nozzle bore, where it is connected to the manifold, is enlarged to form a smooth transition between its bore and that of the split channel to assist in preventing the formation of air bubbles in the split channel.

12. A dispensing head as claimed in claim 10, in which the manifold comprises a gas bubble release valve connected to the split channel.

13. A dispensing head as claimed in claim 10, in which each secondary nozzle projects proud of the dispensing head to form the dispensing tip.

14. A dispensing head as claimed in claim 13, in which the external dimensions of the secondary nozzle reduces in cross-section towards the dispensing tip.

15. A dispensing head as claimed in claim 10, in which the primary nozzle bore, where it is connected to the manifold, is enlarged to provide a smooth transition between it and the split channel.

16. A dispensing head as claimed in claim 10, in which the secondary nozzles are arranged in a matrix of rows and columns.

17. A dispensing head as claimed in claim 10, in which the dispensing head is a two part head in which at least the manifold and the secondary nozzles form the one separate unit releasably connected to the remainder of the dispensing head.

18. A multi nozzle dispensing head for a dispensing assembly for liquid droplets of the order of 10 microlitres or less, the dispensing assembly being of the type comprising:
a pressurised liquid delivery source; and
a dispenser comprising a metering valve connected to the pressurised liquid delivery source and a multi nozzle dispensing head for dispensation of droplets, connected to the metering valve:
the multi nozzle dispensing head comprising:
a primary nozzle, having an internal liquid dispensing primary nozzle bore;
releasable connection means for mounting the dispensing head on the dispenser;
a manifold connected to the primary nozzle adjacent its distal end and forming an internal split channel for reception of liquid from the primary nozzle bore; and
a plurality of secondary nozzles, each having an internal liquid dispensing secondary nozzle bore, each secondary nozzle being connected adjacent its proximal end to the manifold for reception of liquid therefrom and having a dispensing tip adjacent its distal end in which the aggregate resistance to flow in all the secondary nozzle bores is greater than the resistance to flow in the split channel.

19. A dispensing head as claimed in claim 18, in which the resistance to flow is greater by a factor of five.

20. A dispensing head as claimed in claim 18, in which each secondary nozzle bore, where it is connected to the manifold, is enlarged to form a smooth transition between its bore and that of the split channel to assist in preventing the formation of air bubbles in the split channel.

21. A dispensing head as claimed in claim 18, in which the primary nozzle bore, where it is connected to the manifold, is enlarged to provide a smooth transition between it and the split channel.

22. A dispensing head as claimed in claim 18, in which the manifold comprises a gas bubble release valve connected to the split channel.

23. A dispensing head as claimed in claim 18, in which each secondary nozzle projects proud of the dispensing head to form the dispensing tip.

24. A dispensing head as claimed in claim 23, in which the external dimensions of the secondary nozzle reduces in cross-section towards the dispensing tip.

25. A dispensing head as claimed in claim 18, in which the secondary nozzles are arranged in a matrix of rows and columns.

26. A multi nozzle dispensing head as claimed in claim 18, in which the releasable connection means for mounting the dispensing head comprises:
a two-part primary nozzle having a proximal part connected to the metering valve and integral therewith and a distal part connected to the manifold and integral therewith; and
a quick release connector joining the proximal part and the distal part.

27. A dispensing head as claimed in claim 26, in which the resistance to flow is greater by a factor of ten.

28. A dispensing head as claimed in claim 26, in which each secondary nozzle bore, where it is connected to the manifold, is enlarged to form a smooth transition between its bore and that of the split channel to assist in preventing the formation of air bubbles in the split channel.

29. A dispensing head as claimed in claim 26, in which the primary nozzle bore, where it is connected to the manifold, is enlarged to provide a smooth transition between it and the split channel.

30. A dispensing head as claimed in claim 26, in which the manifold comprises a gas bubble release valve connected to the split channel.

31. A dispensing head as claimed in claim 26, in which each secondary nozzle projects proud of the dispensing head to form the dispensing tip.

32. A dispensing head as claimed in claim 31, in which the external dimensions of the secondary nozzle reduces in cross-section towards the dispensing tip.

33. A dispensing head as claimed in claim 26, in which the secondary nozzles are arranged in a matrix of rows and columns.

34. A multi nozzle dispensing head for a dispensing assembly for liquid droplets of the order of 10 microlitres or less, the dispensing assembly being of the type comprising:
a pressurised liquid delivery source;
a dispenser comprising a metering valve connected to the pressurised liquid delivery source and a multi nozzle dispensing head for dispensation of droplets, connected to the metering valve:
the multi nozzle dispensing head comprising:
a primary nozzle, having an internal liquid dispensing primary nozzle bore;
releasable connection means for mounting the dispensing head on the dispenser;
a manifold connected to the primary nozzle adjacent its distal end and forming an internal split channel for reception of liquid from the primary nozzle bore; and
a plurality of secondary nozzles, each having an internal liquid dispensing secondary nozzle bore, each secondary nozzle being connected adjacent its proximal end to the manifold for reception of liquid therefrom and having a dispensing tip adjacent its distal end wherein the resistance to flow in all the secondary nozzle bores is approximately ten times greater than the resistance to flow in the split channel.

35. A dispensing head as claimed in claim 34, in which each secondary nozzle bore, where it is connected to the manifold, is enlarged to form a smooth transition between its bore and that of the split channel to assist in preventing the formation of air bubbles in the split channel.

36. A dispensing head as claimed in claim 34, in which the primary nozzle bore, where it is connected to the manifold, is enlarged to provide a smooth transition between it and the split channel.

37. A dispensing head as claimed in claim 34, in which the manifold comprises a gas bubble release valve connected to the split channel.

38. A dispensing head as claimed in claim 34, in which each secondary nozzle projects proud of the dispensing head to form the dispensing tip.

39. A dispensing head as claimed in claim 38, in which the external dimensions of the secondary nozzle reduces in cross-section towards the dispensing tip.

40. A dispensing head as claimed in claim 34, in which the secondary nozzles are arranged in a matrix of rows and columns.

41. A multi nozzle dispensing assembly for liquid droplets of the order of 10 microlitres or less, comprising:
a pressurised liquid delivery source;
a dispenser comprising a metering valve connected to the pressurised liquid delivery source and a multi nozzle dispensing head for dispensation of droplets, connected to the metering valve:
the multi nozzle dispensing head comprising:
a primary nozzle, having an internal liquid dispensing primary nozzle bore, connected to the metering valve for reception of pressurised liquid therefrom;
a manifold connected to the primary nozzle adjacent its distal end and forming an internal split channel for reception of liquid from the primary nozzle bore; and
a plurality of secondary nozzles, each having an internal liquid dispensing secondary nozzle bore, each secondary nozzle being connected adjacent its proximal end to the manifold for reception of liquid therefrom and having a dispensing tip adjacent its distal end wherein the aggregate resistance to flow in all the secondary nozzles is greater than the resistance to flow in the split channel.

42. A dispensing assembly as claimed in claim 41, in which each secondary nozzle bore, where it is connected to the manifold, is enlarged to form a smooth transition between its bore and that of the split channel to assist in preventing the formation of air bubbles in the split channel.

43. A dispensing assembly as claimed in claim 41, in which the primary nozzle bore, where it is connected to the manifold, is enlarged to provide a smooth transition between it and the split channel.

44. A dispensing assembly as claimed in claim 41, in which the manifold comprises a gas bubble release valve connected to the split channel.

45. A dispensing assembly as claimed in claim 41, in which each secondary nozzle projects proud of the dispensing head to form the dispensing tip.

46. A dispensing assembly as claimed in claim 45, in which the external dimensions of the secondary nozzle reduces in cross-section towards the dispensing tip.

47. A dispensing assembly as claimed in claim 41, in which the secondary nozzles are arranged in a matrix of rows and columns.

48. A dispensing assembly as claimed in claim 41, in which the dispensing head is a two part head in which at least the manifold and the secondary nozzles form the one separate unit releasably connected to the remainder of the dispensing head.

49. A dispensing assembly as claimed in claim 48, in which the separate unit comprises part of the primary nozzle, the other part being integral with the metering valve.

50. A dispensing assembly as claimed in claim 41, in which the resistance to flow is greater by a factor of ten.

51. A dispensing assembly as claimed in claim 50, in which each secondary nozzle bore, where it is connected to the manifold, is enlarged to form a smooth transition between its bore and that of the split channel to assist in preventing the formation of air bubbles in the split channel.

52. A dispensing assembly as claimed in claim 50, in which the manifold comprises a gas bubble release valve connected to the split channel.

53. A dispensing assembly as claimed in claim 50, in which each secondary nozzle projects proud of the dispensing head to form the dispensing tip.

54. A dispensing assembly as claimed in claim 53, in which the external dimensions of the secondary nozzle reduces in cross-section towards the dispensing tip.

55. A dispensing assembly as claimed in claim 50, in which the primary nozzle bore, where it is connected to the manifold, is enlarged to provide a smooth transition between it and the split channel.

56. A dispensing assembly as claimed in claim 50, in which the secondary nozzles are arranged in a matrix of rows and columns.

57. A multi nozzle dispensing assembly for liquid droplets of the order of 10 microlitres or less comprising:
a pressurised liquid delivery source;
a dispenser comprising a metering valve connected to the pressurised liquid delivery source and a multi nozzle dispensing head for dispensation of droplets, connected to the metering valve:
the multi nozzle dispensing head comprising:
a primary nozzle, having an internal liquid dispensing primary nozzle bore, connected to the metering valve for reception of pressurised liquid therefrom;
a manifold connected to the primary nozzle adjacent its distal end and forming an internal split channel for reception of liquid from the primary nozzle bore;
a plurality of secondary nozzles, each having an internal liquid dispensing secondary nozzle bore, each secondary nozzle being connected adjacent its proximal end to the manifold for reception of liquid therefrom and having a dispensing tip adjacent its distal end in which the aggregate resistance to flow in all the secondary nozzle bores is greater than the resistance to flow in the split channel; and
pressurising means for the liquid delivery source to provide a kinetic energy such that the kinetic energy of an individual droplet is greater than the surface energy of the droplet on the dispensing tip.

58. A dispensing assembly as claimed in claim 57, in which each secondary nozzle bore, where it is connected to the manifold, is enlarged to form a smooth transition between its bore and that of the split channel to assist in preventing the formation of air bubbles in the split channel.

59. A dispensing assembly as claimed in claim 57, in which the primary nozzle bore, where it is connected to the manifold, is enlarged to provide a smooth transition between it and the split channel.

60. A dispensing assembly as claimed in claim 57, in which the manifold comprises a gas bubble release valve connected to the split channel.

61. A dispensing assembly as claimed in claim 57, in which each secondary nozzle projects proud of the dispensing head to form the dispensing tip.

62. A dispensing assembly as claimed in claim 61, in which the external dimensions of the secondary nozzle reduces in cross-section towards the dispensing tip.

63. A dispensing assembly as claimed in claim 57, in which the secondary nozzles are arranged in a matrix of rows and columns.

64. A dispensing assembly as claimed in claim 57, in which the dispensing head is a two part head in which at least the manifold and the secondary nozzles form the one separate unit releasably connected to the remainder of the dispensing head.

65. A dispensing assembly as claimed in claim 57, in which the aggregate resistance to flow in all the secondary nozzle bores is greater by a factor of ten than the resistance to flow in the split channel.

66. A multi nozzle dispensing assembly for liquid droplets of the order of 10 microlitres or less, comprising:
a pressurised liquid delivery source;
a dispenser comprising a metering valve connected to the pressurised liquid delivery source and a multi nozzle dispensing head for dispensation of droplets, connected to the metering valve:
the multi nozzle dispensing head comprising:
a primary nozzle, having an internal liquid dispensing primary nozzle bore, connected to the metering valve for reception of pressurised liquid therefrom;
a manifold connected to the primary nozzle adjacent its distal end and forming an internal split channel for reception of liquid from the primary nozzle bore;
a plurality of secondary nozzles, each having an internal liquid dispensing secondary nozzle bore, each secondary nozzle being connected adjacent its proximal end to the manifold for reception of liquid therefrom and having a dispensing tip adjacent its distal end in which the aggregate resistance to flow in all the secondary nozzle bores is greater than the resistance to flow in the split channel; and
pressurising means for the pressurised liquid delivery source provides a sufficient acceleration to the liquid such that the individual droplets can be detached from the nozzle.

67. A dispensing assembly as claimed in claim 66, in which each secondary nozzle bore, where it is connected to the manifold, is enlarged to form a smooth transition between its bore and that of the split channel to assist in preventing the formation of air bubbles in the split channel.

68. A dispensing assembly as claimed in claim 66, in which the primary nozzle bore, where it is connected to the manifold, is enlarged to provide a smooth transition between it and the split channel.

69. A dispensing assembly as claimed in claim 66, in which the manifold comprises a gas bubble release valve connected to the split channel.

70. A dispensing assembly as claimed in claim 66, in which each secondary nozzle projects proud of the dispensing head to form the dispensing tip.

71. A dispensing assembly as claimed in claim 70, in which the external dimensions of the secondary nozzle reduces in cross-section towards the dispensing tip.

72. A dispensing assembly as claimed in claim 66, in which the secondary nozzles are arranged in a matrix of rows and columns.

73. A dispensing assembly as claimed in claim 66, in which the dispensing head is a two part head in which at least the manifold and the secondary nozzles form the one separate unit releasably connected to the remainder of the dispensing head.

74. A dispensing assembly as claimed in claim 66, in which the resistance to flow is greater by a factor of ten.

75. A multi nozzle dispensing assembly for liquid droplets of the order of 10 microlitres or less comprising:
a pressurised liquid delivery source;
a dispenser comprising a metering valve connected to the pressurised liquid delivery source and a multi nozzle dispensing head for dispensation of droplets, connected to the metering valve:
the multi nozzle dispensing head comprising:
a primary nozzle, having an internal liquid dispensing primary nozzle bore, connected to the metering valve for reception of pressurised liquid therefrom;
a manifold connected to the primary nozzle adjacent its distal end and forming an internal split channel for reception of liquid from the primary nozzle bore;
a plurality of secondary nozzles, each having an internal liquid dispensing secondary nozzle bore, each secondary nozzle being connected adjacent its proximal end to the manifold for reception of liquid therefrom and having a dispensing tip adjacent its distal end in which the aggregate resistance to flow in all the secondary nozzle bores is greater than the resistance to flow in the split channel;
wherein the dimensions of the dispensing head, pressure in the pressurised liquid delivery source and characteristics of the liquid dispensed, satisfy the formula:
$$\frac{ρ \cdot {( {p}_{1} - {p}_{2} )}^{2} \cdot {r}^{14 / 3}}{σ \cdot {η}^{2} \cdot {l}^{5 / 3}} \geq 65 \cdot K > 100$$
where p₁−p₂ is the effective pressure difference across the multi nozzle dispensing head, provided by the liquid delivery source, l is the effective length of the multi nozzle dispensing head, r is the effective radius of the inner bore of the dispensing head, ρ is the liquid density, σ is the liquid surface tension, η is the viscosity of the liquid and K is a dimensionless constant whose value is a function of the internal shape of the dispensing head.

76. A dispensing assembly as claimed in claim 75, in which each secondary nozzle bore, where it is connected to the manifold, is enlarged to form a smooth transition between its bore and that of the split channel to assist in preventing the formation of air bubbles in the split channel.

77. A dispensing assembly as claimed in claim 75, in which the primary nozzle bore, where it is connected to the manifold, is enlarged to provide a smooth transition between it and the split channel.

78. A dispensing assembly as claimed in claim 75, in which the manifold comprises a gas bubble release valve connected to the split channel.

79. A dispensing assembly as claimed in claim 75, in which each secondary nozzle projects proud of the dispensing head to form the dispensing tip.

80. A dispensing assembly as claimed in claim 79, in which the external dimensions of the secondary nozzle reduces in cross-section towards the dispensing tip.

81. A dispensing assembly as claimed in claim 75, in which the secondary nozzles are arranged in a matrix of rows and columns.

82. A dispensing assembly as claimed in claim 75, in which the dispensing head is a two part head in which at least the manifold and the secondary nozzles form the one separate unit releasably connected to the remainder of the dispensing head.

83. A dispensing assembly as claimed in claim 75, in which the resistance to flow is greater by a factor of ten.
